(19) United States
(12) Patent Application Publication
(10) Pub. No.: US 2026/0332008 A1
(43) Pub. Date: Oct. 22, 2026

(54) AIR PUMP

(71) Applicant: T-MAX (HANGZHOU) TECHNOLOGY CO., LTD., Hangzhou (CN)

(72) Inventors: Hangfei YU, Hangzhou (CN); Yali CHEN, Hangzhou (CN); Taotao LI, Hangzhou (CN)

(21) Appl. No.: 19/538,172

(22) Filed: Feb. 12, 2026

(30) Foreign Application Priority Data
Apr. 21, 2025 (CN) 202510499573.1
Apr. 21, 2025 (CN) 202520753473.2

(51) Int. Cl. H02K 11/33; H02K 5/10

(52) U.S. Cl. CPC H02K 11/33; H02K 5/10

(57) ABSTRACT

An air pump includes a housing, a motor, a motor controller and a control panel. The motor is arranged in the housing and includes a motor housing and a motor shaft. The motor housing has a first end and a second end along an axial direction of the motor shaft. An output end of the motor shaft extends out of the motor housing from the first end of the motor housing. The motor controller is arranged on an outer end face of the second end of the motor housing. The control panel is arranged on an outer wall of the housing and is connected to the motor controller.

### CROSS-REFERENCE TO RELATED APPLICATIONS

The present application claims the benefits of and priorities to Chinese Patent Application No. 202510499573.1, filed on Apr. 21, 2025, and Chinese Patent Application No. 202520753473.2 filed on Apr. 21, 2025. The entire contents of aforementioned patent applications are incorporated by reference for all purposes.

### TECHNICAL FIELD

This patent document relates to the field of air pumps.

### BACKGROUND

An air pump is a mechanical device that moves air from the atmosphere into a confined space, such as a tire, by reducing or increasing volume to create pressure.

### SUMMARY

Disclosed are devices, systems and methods for an air pump with a high integration and a small size.

In some embodiments in accordance with the present technology, an air pump includes a housing; a motor arranged in the housing and including a motor housing and a motor shaft, the motor housing having a first end and a second end along an axial direction of the motor shaft, and an output end of the motor shaft extending out of the motor housing from the first end of the motor housing; a motor controller arranged on an outer end face of the second end of the motor housing; and a control panel arranged on an outer wall of the housing and connected to the motor controller.

The subject matter described in this patent document can be implemented in specific ways that provide one or more of the following features.

### BRIEF DESCRIPTION OF THE DRAWINGS

FIG. 1 shows a perspective view of an example embodiment of an air pump in accordance with the present technology.

FIG. 2 shows a sectional view of an example embodiment of an air pump in accordance with the present technology.

FIG. 3 shows a schematic view of a rear end cover of an example air pump, in accordance with the present technology.

FIG. 4 shows a schematic view of a motor controller of an example air pump, in accordance with the present technology.

FIG. 5 shows a schematic view of a motor controller of an example air pump, in accordance with the present technology, from another perspective.

FIG. 6 shows an exploded view of a motor controller of an example air pump, in accordance with the present technology.

FIG. 7 shows a schematic view of a carbon brush assembly and a rear end cover of an example air pump connected with each other, in accordance with the present technology.

FIG. 8 shows a schematic view illustrating an arrangement of a lamp assembly and a control panel of an example air pump, in accordance with the present technology.

### DETAILED DESCRIPTION

As an auxiliary device for a vehicle, an air pump may be used for inflation and emergency rescue, which may usually also be referred to as a vehicular air pump. Conventional air pumps typically have a large size, which occupies significant space when placed in the vehicle. Additionally, conventional air pumps in the related arts suffer from issues such as poor component integration, complex assembly, single-functionality, and poor user experience.

Disclosed are devices, systems and methods for an air pump with a high integration and a small size. The disclosed air pumps are envisioned to resolve problems with conventional air pumps and provide efficient component integration, simple assembly, multi-functionalities, and positive user experiences.

In some aspects, an air pump 100, in accordance with example embodiments of the present technology, is described below.

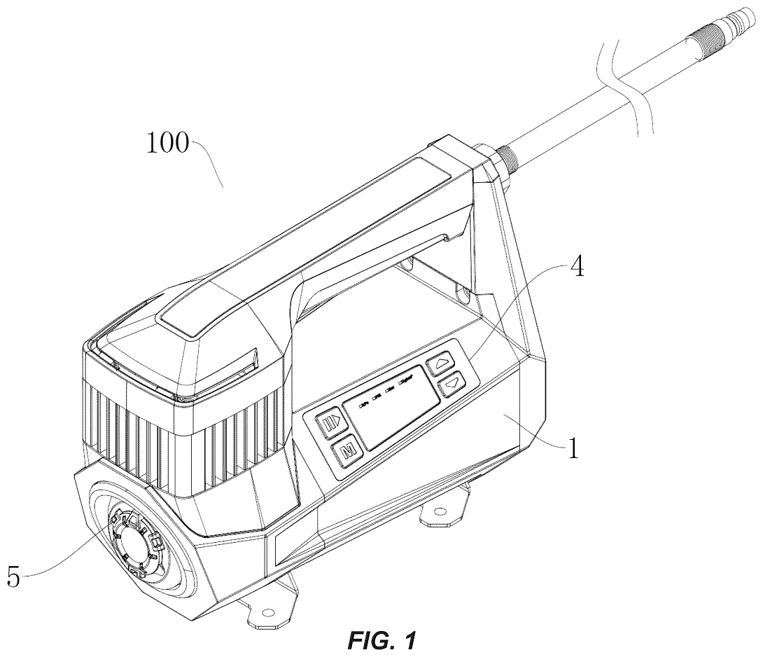

As shown in FIGS. 1 to 8, the air pump 100 includes a housing 1, a motor 2, a motor controller 3, and a control panel 4.

The motor 2 is arranged in the housing 1. The motor 2 includes a motor housing 21 and a motor shaft 23. A stator may be arranged at an inner wall of the motor housing 21, and a rotor corresponding to the stator may be arranged on the motor shaft 23. The motor housing 21 has a first end and a second end along an axial direction of the motor shaft 23, and an output end 231 of the motor shaft 23 extends out of the motor housing 21 from the first end of the motor housing 21. The output end 231 of the motor shaft 23 is in transmission connection with an air supply unit of the air pump 100. For example, after the motor 2 is powered on, the output end 231 of motor shaft 23 outputs torque and drives the air supply unit to move to provide compressed air, which flows out through an air outlet channel in the housing 1.

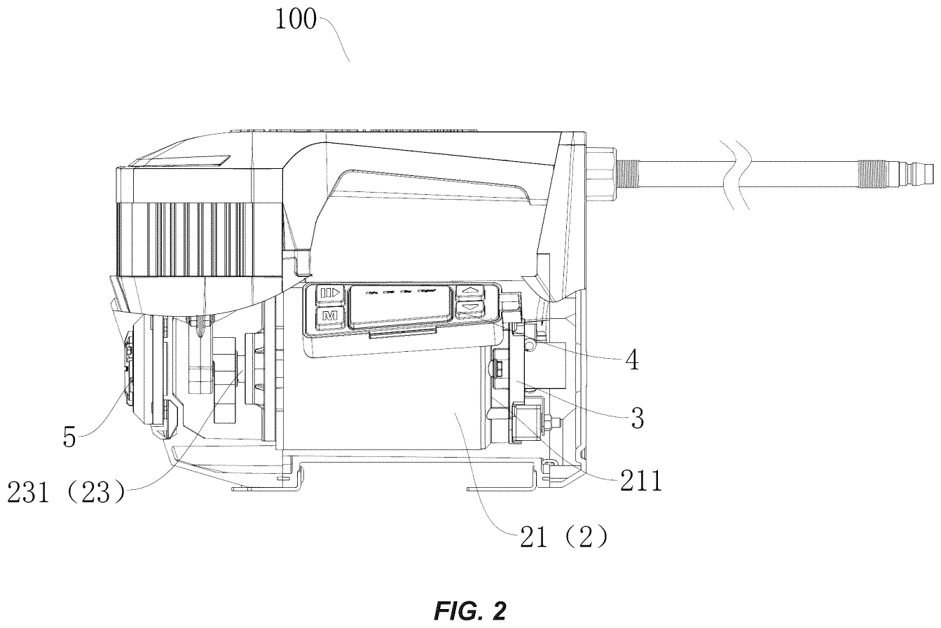

As shown in FIGS. 2 to 6, the motor controller 3 can be arranged on an outer end face of the second end of the motor housing 21. For example, by integrating the motor controller 3 at the second end of the motor housing 21, an axial space of the motor 2 is fully utilized to achieve an integrated design of the motor 2 and the motor controller 3. In this example embodiment, the second end of the motor housing 21 is used as a seat body, which not only facilitates an integrated assembly of the motor controller 3 and the motor 2, e.g., resulting in a more compact structure and a good stability, but also reduces a length of a cable between the motor 2 and the motor controller 3, e.g., avoiding noise caused by collisions between the cable and the housing 1 during operation. Meanwhile, a fixed structure for the cable is reduced, which is more convenient for later assembly. In this example embodiment, a space in the housing 1 is more effectively utilized, e.g., thus improving space utilization and avoiding interference between the motor controller 3 and other components in the housing 1.

Compared with conventional air pumps, for example, under the premise of unchanged performance, the air pump 100 according to example embodiments of the present technology facilitates overall more efficient and effective integration, has a smaller size, occupies less space when carried in a vehicle, is easy to store, and provides a better user experience.

In some embodiments of the air pump 100, the control panel 4 is arranged at an outer wall of the housing 1 and connected to the motor controller 3. The control panel 4 may set and adjust modes of the air pump 100 and may also display information such as a current inflation pressure, e.g., thus facilitating users to make personalized settings, which may be applied to different working conditions and has a good practicality.

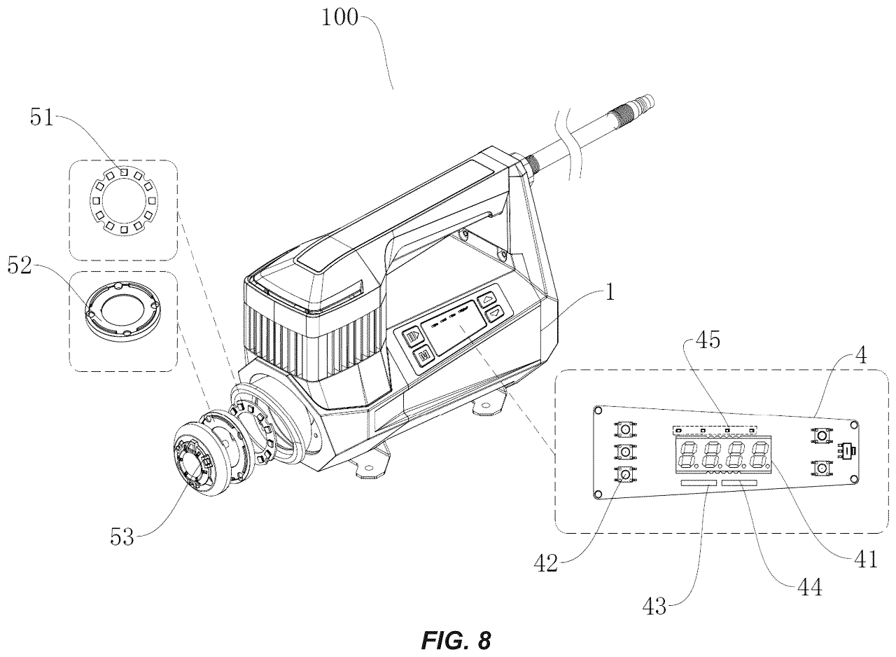

In some example embodiments, and as shown in FIG. 8, the air pump 100 may further include a lamp assembly 5 arranged on the housing 1. In such embodiments, for example, the control panel 4 is connected to the lamp assembly 5. The lamp assembly 5 has a plurality of lamp bodies 51 configured to respectively display different working states.

In some implementations in accordance with the present technology, the air pump 100 may prompt the users of a phased working state of the air pump 100 through information, e.g., such as colors and flashing frequencies of different lamp bodies 51, so that the users obtain a current working condition of the air pump 100. By providing various forms of information feedback, the air pump 100 can help users have sufficient time to operate the air pump 100, can improve the users'awareness of the working state of the air pump, and can enhance the user experience.

Some example embodiments of the air pump 100 can include specific features and/or functionalities, as described below.

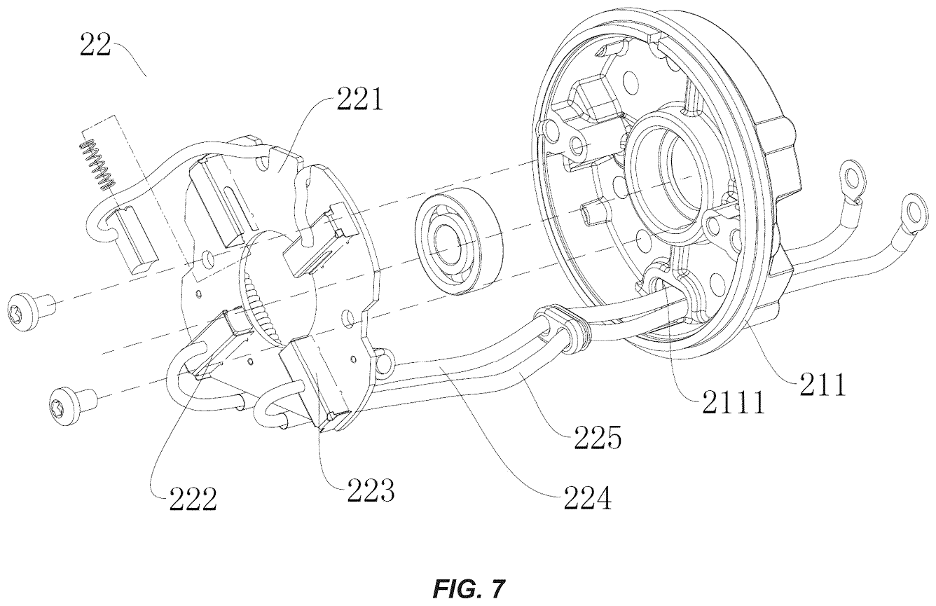

For example, in some embodiments, the air pump 100 includes the housing 1, an air supply assembly, the motor 2, the motor controller 3, the control panel 4, and the lamp assembly 5. The motor 2 is arranged in the housing 1. The motor 2 can include the motor housing 21, the motor shaft 23, the stator, the rotor, and, as shown in FIG. 7, a carbon brush assembly 22. The stator can be arranged at the inner wall of the motor housing 21, and the rotor can be arranged on the motor shaft 23.

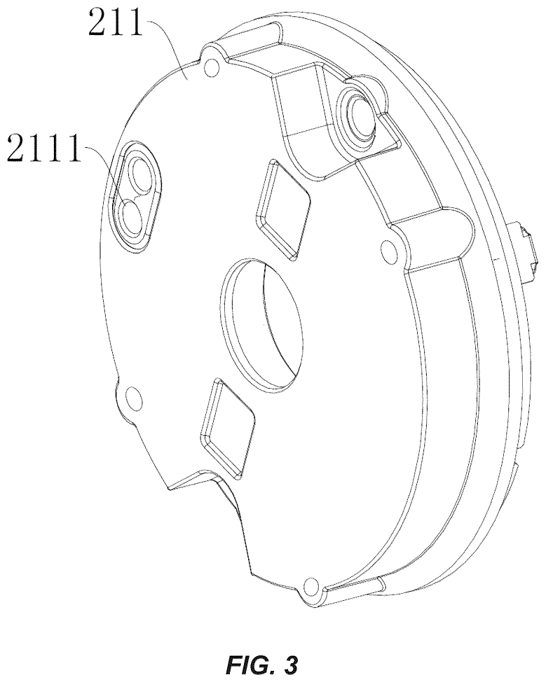

As shown in FIGS. 2 and 3, the motor housing 21 has the first end and the second end along the axial direction of the motor shaft 23. In some embodiments, the first end of the motor housing 21 has a front end cover, and the second end of the motor housing 21 has a rear end cover 211. The rear end cover 211 can be provided with a wire passing hole 2111. The output end 231 of the motor shaft 23 extends from the front end cover of the first end of the motor housing 21.

The output end 231 of the motor shaft 23 is in transmission connection with an air supply unit of the air pump 100. The air supply unit may be a piston cylinder, and a piston rod of the piston cylinder can be configured to be in transmission connection with the output end 231 of the motor shaft 23, e.g. thereby converting a rotational motion of the motor shaft 23 into a linear reciprocating motion of the piston rod. For instance, air suction and air exhaust can be achieved through a reciprocating movement of the piston in the piston cylinder. After the motor 2 is powered on, for example, the output end 231 of motor shaft 23 outputs torque and drives the air supply unit to move to provide compressed air, which flows out through an air outlet channel in the housing 1.

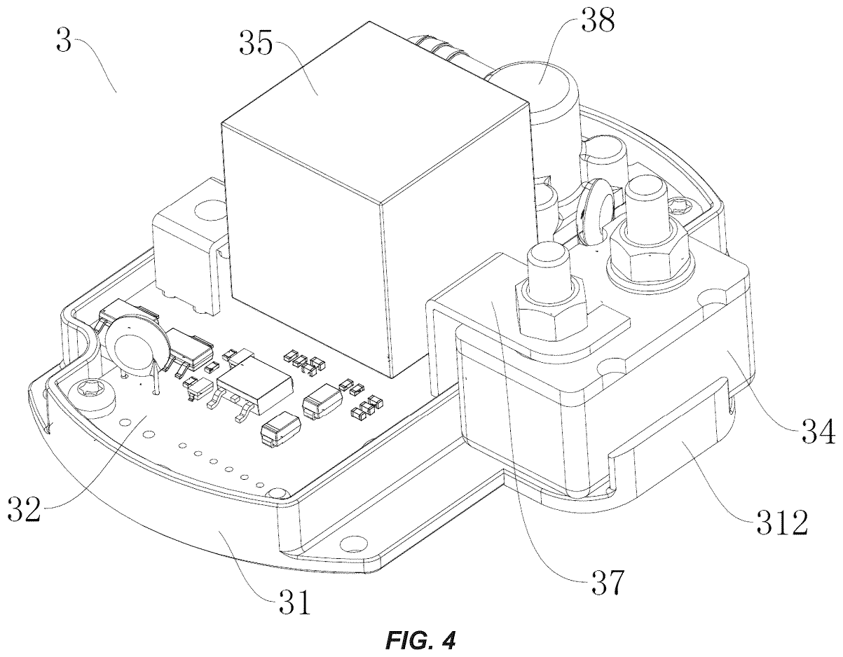

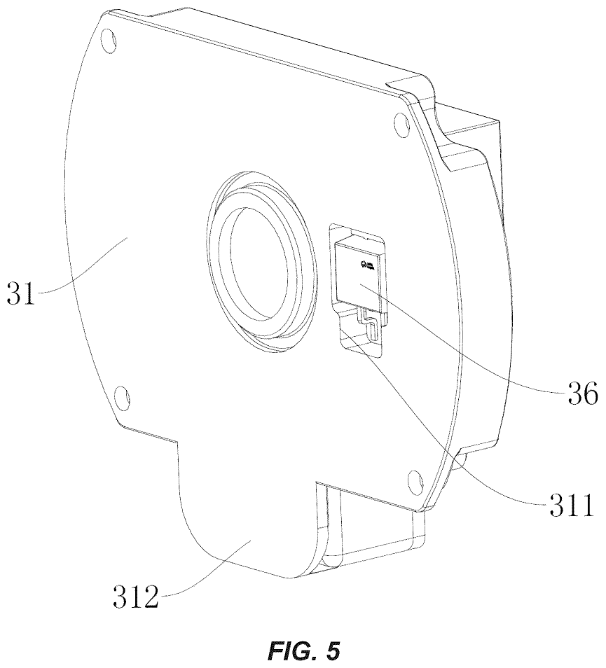

As shown in FIGS. 4 and 5, the motor controller 3 can be arranged on an outer end face of the rear end cover 211 of the second end of the motor housing 21. Specifically, in some embodiments, the motor controller 3 includes a base 31, a PCB board 32, and electrical components arranged on the PCB board 32. The base 31 is arranged on the outer end face of the rear end cover 211 and abuts against the outer end face of the rear end cover 211. The base 31 and the rear end cover 211 may be fixedly connected by means of a connecting piece such as a bolt.

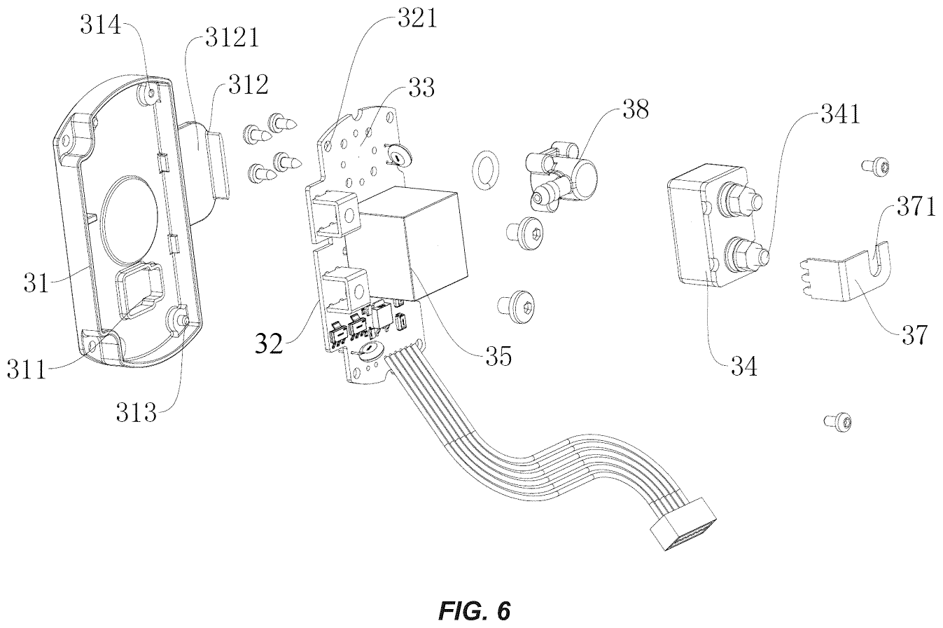

As shown in FIG. 6, the PCB board 32 can be arranged on the base 31 and located at a side of the base 31 facing away from the motor housing 21. The side of the base 31 facing away from the motor housing 21 is provided with two positioning pins 313 and two first connection holes 314. The two positioning pins 313 and the two first connection holes 314 are arranged at intervals along a circumferential direction of the PCB board 32, the two positioning pins 313 are arranged approximately diagonally, and the two first connection holes 314 are also arranged approximately diagonally. The PCB board 32 is provided with four second connection holes 321, in which the positioning pins 313 are correspondingly inserted in two second connection holes 321, and connecting pieces such as bolts are provided between the other two second connection holes 321 and the two first connection holes 314. During assembly, for example, the positioning pins 313 is first aligned and inserted in the two second connection holes 321 on the PCB board 32 to achieve pre-assembly, and then the connecting pieces such as bolts are arranged in the corresponding second connection holes 321 and first connection holes 314 to fix the PCB board 32 on the base 31.

In the embodiment, by providing the positioning pins 313, it facilitates the later assembly and positioning, improves the assembly efficiency and positioning accuracy, and makes the structural stability of the motor 2 and the motor controller 3 better.

The electrical components include an air pressure sensor 33, an overload protector 34, a relay 35, and a temperature sensor 36. The PCB board 32 is provided with an air tube connector 38, and the air tube connector 38 may be fixedly connected to the PCB board 32 by means of connecting pieces such as bolts. The air pressure sensor 33 may be integrated on the PCB board 32. The air pressure sensor 33 is connected to a first end of the air tube connector 38. To improve sealing performance, an annular sealing ring may be provided at the first end of the air tube connector 38 to prevent air leakage after the air tube connector 38 abuts against the air pressure sensor 33. A second end of the air tube connector 38 is in communication with the air outlet channel in the housing 1. The air pressure sensor 33 may obtain an air pressure value in the air outlet channel in real time to determine a current inflation pressure of the air pump 100. The air pressure sensor 33 may transmit the detected data to the control panel 4, which is displayed on the control panel 4 or indicated through the lamp assembly 5.

In some embodiments, the base 31 is generally oblong, for example. Two ends of the base 31 in a length direction of the base 31 are generally flush with a circumferential outer edge of the rear end cover 211, and there is a certain spacing distance between two sides of the base 31 in a width direction of the base 31 and the circumferential outer edge of the rear end cover 211. An outer peripheral side of the base 31 is provided with a mounting part 312. Specifically, the mounting part 312 is arranged at a side of the base 31 in the width direction of the base 31, and an outer edge of the mounting part 312 may be generally flush with the circumferential outer edge of the rear end cover 211.

The mounting part 312 is a generally L-shaped plate, and a mounting slot 3121 is defined between the mounting part 312 and a side wall of the base 31. The overload protector 34 is arranged in the mounting slot 3121 and abuts against the mounting part 312 and the side wall of the base 31. The overload protector 34 is connected to the PCB board 32 through an electrical connecting plate 37. The electrical connecting plate 37 is L-shaped. An end of the electrical connecting plate 37 adjacent to the overload protector 34 has a notch 371, and an opening direction of the notch 371 is parallel to a length direction of the mounting slot 3121. A connection terminal 341 of the overload protector 34 is arranged in the notch 371. When mounting the overload protector 34, the overload protector 34 may be pushed into the mounting slot 3121 along the length direction of the mounting slot 3121. After the overload protector 34 is pushed into place, the connection terminal 341 of the overload protector 34 is arranged in the notch 371, and the connection terminal 341 and the electrical connecting plate 37 are fastened together through a nut. No other fixed structure is needed to fix the overload protector 34, allowing convenient disassembly and assembly while ensuring its structural stability.

The base 31 defines a through hole 311. The temperature sensor 36 is arranged at a side of the PCB board 32 facing the motor housing 21, and is arranged corresponding to the through hole 311. The temperature sensor 36 may be closer to the rear end cover 211 of the motor 2 through the through hole 311, facilitating more accurate acquisition of an operating temperature of the motor 2.

In example embodiments, by integrating the motor controller 3 at the second end of the motor housing 21, the axial space of the motor 2 is fully utilized to achieve an integrated design of the motor 2 and the motor controller 3. For example, in some embodiments, the rear end cover 211 of the second end of the motor housing 21 is used as a seat body, which not only facilitates an integrated assembly of the motor controller 3 and the motor 2, e.g., resulting in a more compact structure and a good stability, but also reduces a length of a cable between the motor 2 and the controller, e.g., avoiding noise caused by collisions between the cable and the housing 1 during operation. Meanwhile, the fixed structure for the cable and the space occupied by the cable are reduced, which is convenient for later assembly.

In example embodiments, the space in the housing 1 may be more effectively utilized, thus improving space utilization and avoiding interference between the motor controller 3 and other components in the housing 1. In the air pump 100 of this example embodiment, the air pressure sensor 33, the overload protector 34, the relay 35, and the temperature sensor 36 may be integrated on the rear end cover 211 of the motor 2 even when an internal cavity space is limited, so that the air pump 100 has functions such as air pressure detection, temperature detection, overload protection, and motor control. The motor controller 3 may be filled with a potting compound, which may absorb vibrations and impact forces after solidification, and also has functions such as waterproofing and moisture-proofing to protect the electrical components from damage. The motor controller 3 may achieve IP68-level component protection.

In some example embodiments, the carbon brush assembly 22 is arranged inside the rear end cover 211. The carbon brush assembly 22 includes a brush holder 221, two groups of carbon brushes mounted on the brush holder 221, a positive cable 224, and a negative cable 225. The brush holder 221 is fixedly connected to the rear end cover 211 by means of connecting pieces such as bolts. Each group of carbon brushes includes a first carbon brush 222 and a second carbon brush 223, the first carbon brush 222 is connected to the positive cable 224, and the second carbon brush 223 is connected to the negative cable 225.

The positive cable 224 and the negative cable 225 are led out through the wire passing hole 2111. The motor controller 3 and the wire passing hole 2111 are arranged in a misaligned manner in the axial direction of the motor shaft 23. Specifically, the wire passing hole 2111 and the mounting part 312 are located at two sides of the base 31 in the width direction of the base 31, respectively. The positive cable 224 and the negative cable 225 will not interfere with the motor controller 3 after passing through the wire passing hole 2111, which also facilitates the connection between the cable and the motor controller 3.

In some embodiments, for example, the lamp assembly 5 and the control panel 4 each are arranged at the outer wall of the housing 1, and the lamp assembly 5 is connected to the control panel 4. The lamp assembly 5 can include the plurality of lamp bodies 51, a light-transmitting ring 52 arranged on the housing 1, and an outer cover 53. The light-transmitting ring 52 and the outer cover 53 can be sequentially arranged outside the lamp bodies 51. For example, in some embodiments, the lamp bodies 51 may be RGB light beads. The light-transmitting ring 52 may be made of PC material and contains a certain amount of diffusion powder, which may achieve a softer light effect when the lamp assembly 5 emits light.

The plurality of lamp bodies 51 are configured to respectively display different working states of the air pump. For example, in some embodiments, the plurality of lamp bodies 51 can include a first lamp body, a second lamp body, a third lamp body, a fourth lamp body, a fifth lamp body, and a sixth lamp body. In some embodiments, two first lamp bodies, two second lamp bodies, two third lamp bodies, two fourth lamp bodies, two fifth lamp bodies, and two sixth lamp bodies may be provided; that is, twelve lamp bodies 51 can be evenly arranged in a ring shape along a circumferential direction, and the same lamp bodies may be arranged opposite each other to enhance the visual effect of lighting. The plurality of lamp bodies configured to display different working states may have different colors and/or different flashing frequencies. In implementations, for example, the lighting performance of different lamp bodies may be controlled through programming via a controller (e.g., embodied by a data processing device), which enables users to customize a plurality of RGB modes, e.g., thus making the light emitted by different lamp bodies more recognizable and enhancing the user experience.

In some implementations, for example, the first lamp body can be configured to display an air pressure state from 0 to a first threshold. The first threshold may be 50% to 80% of a preset saturation pressure. In some embodiments, the first threshold is 50%, 66%, 74%, or 80% of the preset saturation pressure. Preferably, the first threshold, in accordance with some embodiments of the disclosed technology, is 70% of the preset saturation pressure. The first lamp body may be a green light lamp, for example. When an air pressure during inflation is between 0 and 70% of the preset saturation pressure, the first lamp body flashes slowly, which may prompt the user that it currently is in an inflation state, that the current inflation pressure is relatively low, that a certain period of time is still required for the inflation to complete, and that the user only needs to wait patiently.

In some implementations, for example, the second lamp body can be configured to display an air pressure state from the first threshold to a second threshold. The second threshold may be 90% to 98% of the preset saturation pressure. In some embodiments, the second threshold is 90%, 93%, 97%, or 98% of the preset saturation pressure. Preferably, the second threshold, in accordance with some embodiments of the disclosed technology, is 95% of the preset saturation pressure. The second lamp body may be a yellow light lamp, for example. When an air pressure during inflation is between 70% of the preset saturation pressure and 95% of the preset saturation pressure, the second lamp body flashes slowly, which may prompt the user that the current inflation pressure is close to the saturation pressure and that the working state of the air pump needs to be paid attention to.

In some implementations, for example, the third lamp body can be configured to display an air pressure state from the second threshold to the preset saturation pressure. The third lamp body may be a red light lamp, for example. When an air pressure during inflation is between 95% of the preset saturation pressure and 100% of the preset saturation pressure, the third lamp body flashes slowly, which may prompt the user that the air pump needs to be turned off, or prompt the user that the air pump will automatically stop working soon and the next tire inflation operation may be carried out.

In some implementations, for example, the fourth lamp body can be configured to display a deflation state. The fourth lamp body is a blue light lamp, for example. When the blue light lamp flashes slowly, it may prompt the user that it is currently in the deflated state.

In some implementations, for example, the fifth lamp body can be configured to display a resting state. The fifth lamp body may be a white light lamp, for example. When the white light lamp is constantly on, it may prompt the user that it is currently in the resting state (non-working state). The fifth lamp body may also be configured as a breathing lamp, a chasing lamp, a multi-color constant lamp, etc.

In some implementations, for example, the sixth lamp body can be used to display the abnormal state. The sixth lamp body may be a red light lamp, for example. When the red light lamp is constantly on, it may prompt the user that the air pump is in an abnormal state, such as overheating, hardware errors, excessive air pressure and other faults, facilitating the user to take measures as soon as possible.

In such embodiments, for example, the control panel 4 has a display panel 41, a mode indicator light 45, a button 42, a first interface 43 and a second interface 44. The first interface 43 is connected to the motor controller 3, and the second interface 44 is connected to the lamp assembly 5. The button 42 may be configured for mode adjustment and function setting, and may also serve as a start/stop button. The mode indicator light 45 may display a current mode state through a constant lighting. The display panel 41 may display information such as an air pressure unit and an air pressure value, which is convenient for the user to carry out personalized configurations. It may be applied to different working condition occasions and has good practicability.

The control panel 4 may produce feedback of an obtained working state information of the air pump 100 to the user through the colors and/or the flashing frequencies of the lamp bodies and/or other ways, and may prompt the user of the phased working state of the air pump, e.g., so that the users obtain the current working condition of the air pump. By providing various forms of information feedback, it helps users have sufficient time to operate the air pump, improves the user's awareness of the working state of the air pump, and enhances the user experience.

The air pump according to the example embodiments of the present technology described herein has a high overall integration, a small size, occupies less space when carried in a vehicle, is easy to store, and provides a better user experience.

### Conclusion

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In the present disclosure, it should be understood that the orientation or position relationship indicated by the terms “center,” “longitudinal,” “transverse,” “length,” “width,” “thickness,” “up,” “down,” “front,” “rear,” “left,” “right,” “vertical,” “horizontal,” “top,” “bottom,” “inner,” “outer,” “clockwise,” “counterclockwise,” “axial,” “radial,” and “circumferential” and the like, is based on the orientation or position relationship shown in the accompanying drawings, which is only for the convenience of describing the present technology and simplifying the description, and does not indicate or imply that the referred device or element must have a specific orientation, and be constructed and operated in a specific orientation, so it cannot be understood as a limitation of the present technology.

In addition, the terms “first” and “second” are only used for purpose of description, and cannot be understood as indicating or implying relative importance or implicitly indicating the number of indicated technical features. Therefore, the feature defined as “first” or “second” may explicitly or implicitly include at least one such feature. In the present disclosure, “a plurality of” means at least two, such as two, three, etc., unless otherwise specifically defined.

In the present disclosure, unless otherwise expressly defined, terms such as “install/mount,” “interconnect,” “connect,” and “fix” shall be understood broadly, and may be, for example, fixed connections, detachable connections, or integral connections; may also be mechanical or electrical connections or intercommunication; may also be direct connections or indirect connections via intervening media; may also be inner communications or interactions of two elements, unless otherwise specifically defined. For those skilled in the art, the specific meaning of the above terms in the present disclosure may be understood according to the specific situations.

In the present disclosure, unless otherwise expressly defined, the first feature “below,” “under,” “on bottom of,” “above,” “on,” or “on top of” the second feature may include an embodiment in which the first feature is in direct contact with the second feature, or the first feature is in indirect contact with the second feature through an intermediate media. And, the first feature “above,” “on,” or “on top of” the second feature may include an embodiment in which the first feature is right or obliquely “above,” “on,” or “on top of” the second feature, or just means that the first feature is at a height higher than that of the second feature. The first feature “below,” “under,” or “on bottom of” the second feature may include an embodiment in which the first feature is right or obliquely “below,” “under,” or “on bottom of” the second feature, or just means that the first feature is at a height lower than that of the second feature.

In the present disclosure, terms such as “an embodiment,” “some embodiments,” “an example,” “a specific example,” or “some examples” means that a particular feature, structure, material, or characteristic described in connection with the embodiment or example is included in at least one embodiment or example of the present technology. Thus, the appearances of these terms in various places throughout this specification are not necessarily referring to the same embodiment or example of the present technology. Furthermore, the particular features, structures, materials, or characteristics may be combined in one or more embodiments or examples in any suitable manner. In addition, without contradiction, those skilled in the art may combine and unite different embodiments or examples or features of the different embodiments or examples described in this specification.

Although the embodiments of the present technology have been shown and described above, it may be understood that the above embodiments are illustrative and shall not be understood as limitation to the present technology, and changes, modifications, alternatives and variations may be made in the above embodiments within the scope of the present technology by those skilled in the art.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. An air pump, comprising:
a housing;
a motor arranged in the housing and comprising a motor housing and a motor shaft, the motor housing having a first end and a second end along an axial direction of the motor shaft, and an output end of the motor shaft extending out of the motor housing from the first end of the motor housing;
a motor controller arranged on an outer end face of the second end of the motor housing; and
a control panel arranged on an outer wall of the housing and connected to the motor controller.

2. The air pump according to claim 1, wherein the motor controller comprises a base, a PCB board, and an electrical component arranged on the PCB board, the base is arranged on the outer end face of the second end of the motor housing, and the PCB board is arranged on the base and located at a side of the base facing away from the motor housing.

3. The air pump according to claim 2, wherein the electrical component comprises an air pressure sensor, the PCB board is provided with an air tube connector, the air pressure sensor is connected to a first end of the air tube connector, and a second end of the air tube connector is in communication with an air outlet channel in the housing.

4. The air pump according to claim 2,
wherein the base is provided with a positioning pin and a first connection hole, the PCB board is provided with a plurality of second connection holes, the positioning pin is correspondingly inserted in a part of the plurality of second connection holes, and a connecting piece is provided between the rest of the plurality of second connection holes except the part of the plurality of second connection holes and the first connection hole; and
wherein the electrical component further comprises an overload protector, a relay, and a temperature sensor, wherein an outer peripheral side of the base is provided with an mounting part, a mounting slot is defined between the mounting part and a side wall of the base, the overload protector is arranged in the mounting slot and abuts against the mounting part and the side wall of the base, the overload protector is connected to the PCB board through an electrical connecting plate, an end of the electrical connecting plate adjacent to the overload protector has a notch, an opening direction of the notch is parallel to a length direction of the mounting slot, an connection terminal of the overload protector is arranged in the notch, the base is provided with a through hole, the temperature sensor is arranged at a side of the PCB board facing the motor housing, and the temperature sensor is arranged corresponding to the through hole.

5. The air pump according to claim 1, wherein the motor comprises a carbon brush assembly, the carbon brush assembly comprises a brush holder, a plurality of groups of carbon brushes mounted on the brush holder, a positive cable and a negative cable, each group of carbon brushes comprises a first carbon brush and a second carbon brush, the first carbon brush is connected to the positive cable, and the second carbon brush is connected to the negative cable.

6. The air pump according to claim 5,
wherein the second end of the motor housing has a rear end cover, the motor controller is arranged at an outer side of the rear end cover, the motor controller is filled with a potting compound, and the carbon brush assembly is arranged at an inner side of the rear end cover; and
wherein the rear end cover is provided with a wire passing hole, the positive cable and the negative cable are led out through the wire passing hole, and the motor controller and the wire passing hole are arranged in a misaligned manner in the axial direction of the motor shaft.

7. The air pump according to claim 1, further comprising a lamp assembly arranged on the housing, wherein the control panel is connected to the lamp assembly, and the lamp assembly has a plurality of lamp bodies configured to respectively display different working states.

8. The air pump according to claim 7, wherein the plurality of lamp bodies comprise a first lamp body, a second lamp body, and a third lamp body, the first lamp body is configured to display an air pressure state from 0 to a first threshold, the second lamp body is configured to display an air pressure state from the first threshold to a second threshold, and the third lamp body is configured to display an air pressure state from the second threshold to a preset saturation pressure, wherein the first threshold is greater than 0 and less than the second threshold, and the second threshold is less than the preset saturation pressure.

9. The air pump according to claim 7,
wherein the plurality of lamp bodies comprise a fourth lamp body, a fifth lamp body, and a sixth lamp body, the fourth lamp body is configured to display a deflation state, the fifth lamp body is configured to display a resting state, and the sixth lamp body is configured to display an abnormal state;
wherein the plurality of lamp bodies are arranged in a ring shape, two or more of the plurality of lamp bodies are configured to display a same working state and evenly arranged along a circumferential direction of the lamp assembly, and a part of the plurality of lamp bodies configured to display different working states have different colors and/or different flashing frequencies; and
wherein the lamp assembly further comprises a light-transmitting ring and an outer cover arranged on the housing, and the light-transmitting ring and the outer cover are sequentially arranged outside the plurality of lamp bodies.

10. The air pump according to claim 7, wherein the control panel has a display panel, a mode indicator light, a button, a first interface connected to the motor controller and a second interface connected to the lamp assembly.
